(19) United States
(12) Patent Application Publication
(10) Pub. No.: US 2021/0142770 A1
(43) Pub. Date: May 13, 2021

(54) Electrical stringed instrument

(71) Applicant: NOATRONIC APS, 8000 Aarhus C (DK)

(72) Inventor: Michael Engel, Aarhus (DK)

(21) Appl. No.: 17/047,766

(22) PCT Filed: Apr. 5, 2019
(86) PCT No.: PCT/EP2019/058620

§ 371 Date: Oct. 15, 2020

(30) Foreign Application Priority Data
Apr. 16, 2018 (DK) PA 2018 00166

(51) Int. Cl. G10H 1/06; G10H 1/46; G10H 3/18

(52) U.S. Cl. CPC G10H 1/06; G10H 2240/211; G10H 3/188; G10H 1/46

(57) ABSTRACT

The invention relates to an electrical stringed instrument system comprising an electrical stringed instrument. The electrical stringed instrument comprises i) an audio output circuit electronically connected to said one or more pickups, and to a first channel of a multichannel output jack; and ii) a first communication circuit comprising a variable impedance unit, and electronically connected to a second channel of said multichannel output jack.

### FIELD OF THE INVENTION

The present invention relates to the field of electrical musical instruments of the string type.

### BACKGROUND OF THE INVENTION

This invention relates broadly to electrical musical instruments of the string type. It is typically applicable to an electrical guitar or bass guitar or similar musical instrument having a plurality of stretched strings extending across a body and a neck, between the head of the instrument and a bridge assembly connected to the body, in which the strings are caused to vibrate by plucking or picking same.

In order to derive an output from such an electrical guitar, bass guitar or other similar electrical musical instrument, the instrument is conventionally provided with an electromagnetic pickup comprising a number of magnetic elements (pole pieces) having wound there around a conductive coil. Typically, one such magnetic element is disposed directly beneath each string of the instrument. The strings are constructed of a magnetizable substance, such as steel, and, therefore, become part of the conductive path for the magnetic lines of flux of the pole pieces. Accordingly, when any of the strings are caused to vibrate this causes a disturbance in the magnetic field of the associated pole piece. This has the effect of generating a voltage in the conductive coil which voltage may be suitably amplified and transmitted to a loudspeaker system.

Audio signal processing devices are used to modify an audio signal, for making the tone more interesting to the listener. These audio signal processing devices include, but are not limited to, analog and digital effect pedals, digital multi-effects processors, analog amplifiers, digital amp modelers, digital modelling amplifiers, filters, and equalizers. Each audio signal processing device typically has several control parameters used to shape the tone of the audio signal, as well as on/off switches. These control parameters appear as knobs, sliders, buttons and switches on the control panel of the audio signal processing devices, and may often be controlled by external devices by received analog (e.g. expression pedal) or digital (e.g. midi foot controller) communication signals. It is also well established that musicians desire the ability to manipulate these control parameters and engage/disengage certain effects during a performance. This type of manipulation during a performance is difficult, if the musician constantly moves around on the stage. As an example, when musicians are using stompbox effect pedals or midi foot controllers, they are limited in their movement on the stage, as the sound is controlled by their feet at a fixed location.

### OBJECT OF THE INVENTION

The objective of the present invention is to provide a system that solves some or all the above-mentioned problems.

The present invention allows the user of an electrical stringed instrument to control audio signal processing devices, connected to the instrument, by the use of knobs and/or sliders and/or buttons onboard the instrument. This advantage provides the user with freedom to move around the stage during a performance, while still being able to control the sound.

The present invention may allow the user to use existing holes on the electrical stringed instrument, that before installation where used for other onboard controls of the instrument (e.g. tone potentiometer), thereby avoiding the need to change the appearance or construction of the instrument.

Another advantage of the invention is that the communication signal travels along the same cable as the generated audio signal, but using a different conductor, thereby avoiding the need to use more than one cable, and also avoiding any change of the sound and/or impedance of the audio signal generated by the instrument.

### DESCRIPTION OF THE INVENTION

A first aspect of the present invention relates to an electrical stringed instrument of the type including a body, a neck having a head, a bridge assembly connected to the body, a plurality of metal strings positioned between the head and the bridge assembly, and one or more pickups positioned on the body and beneath said metal strings; the electrical stringed instrument further comprising:
an audio output circuit electronically connected to said one or more pickups, and to a first channel of a multichannel output jack; and
a first communication circuit comprising a variable impedance unit, and electronically connected to a second channel of said multichannel output jack.

A second aspect relates to an electrical stringed instrument system comprising:
a) An electrical stringed instrument of the type including a body, a neck having a head, a bridge assembly connected to the body, a plurality of metal strings positioned between the head and the bridge assembly, and one or more pickups positioned on the body and beneath said metal strings; the electrical stringed instrument further comprising:
an audio output circuit electronically connected to said one or more pickups, and to a first channel of a multichannel output jack; and
a first communication circuit comprising a variable impedance unit, and electronically connected to a second channel of said multichannel output jack.

In the present context, the term “variable impedance unit” may be a variable resistor unit, a variable capacitor unit, or a variable inductor unit. Preferably, the variable impedance unit is a variable resistor unit.

For the most part, electric guitars or electric bass guitars have changed little over the past few decades. To produce sound, electrical guitars or electric bass guitars typically have two or three pickups, which are positioned beneath metal strings. The pickups include one or more electrical coils, which pick up the vibration of the metal strings, in a magnetic field. The electrical output of the coils is output through an audio output circuit electronically connected to the one or more pickups. Typically, electric guitars have an onboard switch for selecting which pickups to be connected. The electrical output of the coils is then amplified, and the amplified signal is reproduced by means of a loud speaker. Typically, each pickup is composed of a single coil of wire having two ends connectable to a guitar audio output circuit.

Electric guitars typically have additional circuitry for processing the electric signals produced by the pickups. The processing circuitry is used to alter different qualities of the tone. To allow the guitar user to adjust the processing of the electronic signal, a guitar typically includes various knobs and buttons for controlling the tone and volume. Hence, in one or more embodiments, the audio output circuit further comprises a processing circuitry.

The core of the invention is the first communication circuit positioned within the electrical stringed instrument. The first communication circuit allows the musician to instruct audio signal processing devices connected, directly or indirectly through a communication unit, to the electrical stringed instrument for processing of the audio signal in accordance with predefined rules. The first communication circuit comprises a variable impedance unit, and is electronically connected to a second channel of a multichannel output jack, i.e. a different channel than the output circuit is connected to. The variable impedance unit may e.g. be a potentiometer, which is a resistor with a movable element positioned by a manual knob or lever. The movable element, typically called a wiper, contacts a resistive strip of material (commonly called the slidewire if made of resistive metal wire) at any point selected by the manual control. The potentiometer's voltage division ratio is strictly a function of resistance and not of the magnitude of applied voltage. Typically, a potentiometer has three terminals. The wiper provides a division of the voltage at two of the terminals controlled by the voltage division ratio. If only two of the terminals are considered and one of them being the wiper terminal, the potentiometer functions as a variable resistor between those two terminals. Hence, a potentiometer functions as a variable resistor set by wiper position. By varying the resistance through the first communication circuit, each individual value or range of values may represent a code for a specific instruction for the audio signal processing device(s) connected. In one or more embodiments, the variable resistor is operably connected to a rotary or slidable knob mounted on the body of the electrical stringed instrument. As an example, the rotary switch or potentiometer may be replacing an existing tone potentiometer inside the electrical stringed instrument.

Alternatively, the variable impedance unit may be a multi-position switch, e.g. rotary switch or slide switch, which switches between multiple circuits with different impedances. The first communication circuit may in one or more embodiments comprise a switch adapted to switch between a primary circuit and a secondary circuit, and wherein the secondary circuit has a relatively higher impedance than the primary circuit. This configuration allows for doubling the number of possible codes. In one or more embodiments, the switch is operably connected to a push button mounted on the body of the electrical stringed instrument, preferably embedded into the variable impedance unit, e.g. a potentiometer with push/push or push/pull switch.

In one or more embodiments, the output circuit and the communication circuit share the same ground wire.

A second communication circuit may be present in a wireless transmitter unit that is configured for wireless communication with an audio signal processing device. Alternatively, the second communication circuit may be present in a communication unit either built separately or built into the chassis of an audio signal processing device. The second communication circuit is configured to measure and convert the impedance of the first communication circuit to a digital representation. The digital representation is forwarded to a processor, such as a microcontroller, configured for communicating with an audio signal processing device by using digital or analog signals. The processor may in one or more embodiments communicate wirelessly with the audio signal processing device. Preferably, the processor is positioned together with the second communication unit in in a wireless transmitter unit that is configured for communicating with an audio signal processing device.

A third aspect relates to an electrical stringed instrument system comprising:
an electrical stringed instrument according to the present invention; and
a second communication circuit configured to measure the impedance of the first communication circuit, and to convert it to a digital representation.

In one or more embodiments, the second communication circuit comprises an operational amplifier.

In one or more embodiments, the second communication circuit comprises an analog-to-digital converter.

In one or more embodiments, the second communication circuit comprises a processor configured for communicating with an audio signal processing device.

The term “analog” as used with respect to electrical signals has its usual meaning in electrical engineering.

The term “digital” has its usual meaning in electrical and computer engineering.

The term “analog-to-digital converter” (ADC) has its usual and ordinary meaning in the field of electrical engineering.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

The invention is described in more detail in the following detailed description of a preferred embodiment, with reference to the figures.

### BRIEF DESCRIPTION OF THE FIGURES

FIG. 1 shows an exemplary first communication circuit in accordance with various embodiments of the invention;

FIG. 2 shows an exemplary wiring of an electrical stringed instrument in accordance with various embodiments of the invention;

FIG. 3 shows an exemplary second communication circuit in accordance with various embodiments of the invention; and

FIGS. 4-5 are examples of electrical stringed instrument systems in accordance with various embodiments of the invention.

### REFERENCES

100 First communication circuit
110 Variable impedance unit
120 Switch
130 Primary circuit
140 Secondary circuit
150 Capacitor
200 Multichannel output jack
210 First channel
220 Second channel
230 Ground wire
300 Audio output circuit
310 Pickup
320 Tone potentiometer
330 Tone capacitor
340 Volume potentiometer
400 Second communication circuit
410 Operational amplifier
411 Resistor
412 Resistor
420 Analog-to-digital converter
430 Microcontroller
440 Voltage source
450 First resistor
500 Communication unit
600 Multichannel input jack
700 Mono/single-channel output jack

### DETAILED DESCRIPTION OF THE INVENTION

FIG. 1 shows an exemplary first communication circuit 100 in accordance with various embodiments of the invention. The first communication circuit 100 allows the musician to instruct audio signal processing devices connected (see FIGS. 4 and 5), directly or indirectly through a communication unit, to the electrical stringed instrument to process the audio signal in accordance with predefined rules.

The first communication circuit 100 comprises a variable impedance (here shown as a potentiometer) unit 110, and is electronically connected to a second channel 220 of a multichannel output jack 200, i.e. a different channel than the audio output circuit 300 is connected to, which is the first channel 210. The audio output circuit 300 and the communication circuit 100 is shown sharing the same ground wire 230. The potentiometer 110 is here shown with a maximum resistance of 50 kOhm. By varying the resistance through the first communication circuit 100, each individual value or range of values may represent a code for a specific instruction for the audio signal processing device(s) connected thereto. The first communication circuit is also shown comprising a switch 120 adapted to switch between a primary circuit 130 and a secondary circuit 140. The primary circuit 130 is shown comprising a resistor of 6.2 kOhm, while the secondary circuit 140 is shown comprising a resistor of 62 kOhm. This configuration allows for doubling the number of possible codes. The first communication circuit 100 further comprises a capacitor 150 in parallel with the electrical load. The capacitor is here shown with 10 nF. This configuration avoids a noticeable “click or pop” (electrical transient signal) into the common ground terminal each time the switch 120 is activated.

The audio output circuit 300 is here shown with a pickup 310, a tone potentiometer 320, a tone capacitor 330, and a volume potentiometer 340.

FIG. 2 shows the wiring of an electrical stringed instrument (Fender Stratocaster) in accordance with various embodiments of the invention.

In order to receive the instructions via the first communication circuitry 100, a second communication circuit 400 (FIG. 3) may be present in a communication unit 500 either built separately or built into the chassis of the audio signal processing device. Alternatively, the second communication circuit may be integrated into a wireless transmitter unit that is configured for wireless communication with an audio signal processing device.

The second communication circuit 400 is configured to amplify, measure, and convert the voltage from the first communication circuit 100 to a digital representation that is forwarded to a microcontroller configured for communicating with an audio signal processing device.

In FIG. 3, the second communication circuit 400 is shown comprising an operational amplifier 410 configured to amplify the voltage from the first communication circuit 100. The voltage is in this example amplified 21 times via the resistors 411, and 412 of 1 kOhm and 20 kOhm, respectively. The second communication circuit 400 also comprises an analog-to-digital (ADC) converter 420 configured to measure the voltage, pre-amplified by the operational amplifier 410, from the first communication circuit 100 and to convert said voltage to a digital representation. The analog-to-digital converter 420 is here shown connected to a microcontroller (MCU) 430 configured for communicating, preferably wirelessly, with an audio signal processing device. The second communication circuit 400 also comprises a voltage source 440 (150 mV) connected to a first resistor 450 (224 kOhm) of a voltage divider. The second resistor of the voltage divider is a part of the first communication circuit 100 that comprises the potentiometer 110, and the resistors in the primary 130 and secondary 140 circuits.

The communication unit 500 further comprises a multichannel input jack 600 and an audio mono/single-channel output jack 700 electronically connected to one another. The multichannel input jack 600 is electronically connected to the multichannel output jack 200 through a stereo (TRS) cable. This configuration allows for the audio signal to be directly transmitted to the audio mono/single-channel output jack 700, while the communication signal is passed to the second communication circuit 400.

FIGS. 4-5 are examples of electrical stringed instrument systems in accordance with various embodiments of the invention.

1. An electrical stringed instrument system comprising:
an electrical stringed instrument including a body, a neck having a head, a bridge assembly connected to the body, a plurality of metal strings positioned between the head and the bridge assembly, and one or more pickups positioned on the body and beneath said metal strings; the electrical stringed instrument further comprising:
an audio output circuit (300) electronically connected to said one or more pickups, and to a first channel (210) of a multichannel output jack (200); and
a first communication circuit (100) comprising a variable impedance unit (110), and electronically connected to a second channel (220) of said multichannel output jack (200).

2. The electrical stringed instrument system according to claim 1, further comprising:
a second communication circuit (400) configured to measure an impedance of the variable impedance unit of the first communication circuit (100), and to convert a measured impedance to a digital representation.

3. The electrical stringed instrument system according to claim 2, wherein the second communication circuit (400) is positioned in a communication unit (500) that is configured for wireless communication with an audio signal processing device.

4. The electrical stringed instrument system according to claim 3, wherein the communication unit (500) is releasably coupled to the multichannel output jack (200).

5. The electrical stringed instrument system according to claim 2, wherein the second communication circuit (400) further comprises an operational amplifier (410) configured to amplify a voltage from the first communication circuit (100).

6. The electrical stringed instrument system according to claim 5, wherein the second communication circuit (400) further comprises an analog-to-digital converter (420) configured to convert to an amplified voltage from the operational amplifier to a digital representation.

7. The electrical stringed instrument system according to claim 1, wherein the audio output circuit (300) and the first communication circuit (100) share a same ground wire (230).

8. The electrical stringed instrument system according to claim 1, wherein the first communication circuit (100) further comprises a switch (120) adapted to switch between a primary circuit (130) and a secondary circuit (140), and wherein the secondary circuit (140) has a relatively higher impedance than the primary circuit (130).

9. The electrical stringed instrument system according to claim 8, wherein the switch (120) is operably connected to a push button mounted on the body of the electrical stringed instrument.

10. The electrical stringed instrument system according to claim 1, wherein the variable impedance unit (110) is operably connected to a rotary or slidable knob mounted on the body of the electrical stringed instrument.

11. The electrical stringed instrument system according to claim 7, wherein the first communication circuit (100) further comprises a capacitor (150) in parallel with an electrical load between the variable impedance unit (110) and the ground wire (230).

12. The electrical stringed instrument system according to claim 6, wherein the second communication circuit (400) further comprises a processor (430) configured for communicating with an audio signal processing device.

13. The electrical stringed instrument system according to claim 12, wherein the processor (430) is configured for wirelessly communicating with the audio signal processing device.

14. The electrical stringed instrument system according to claim 2, wherein the second communication circuit (400) is positioned in a communication unit (500) either built separately or built into a chassis of an audio signal processing device.

15. The electrical stringed instrument system according to claim 14, wherein communication unit (500) further comprises a multichannel input jack (600) and a single-channel output jack (700) electronically connected to one another.

16. The electrical stringed instrument system according to claim 15, wherein the second communication circuit (400) comprises an analog-to-digital converter (420) configured to convert an amplified voltage from an operational amplifier connected to the variable impedance unit (110) to a digital representation; wherein said analog-to-digital converter (420) is connected to a microcontroller (430) configured for communicating with an audio signal processing device.

17. The electrical stringed instrument system according to claim 1, wherein the electrical stringed instrument is selected from the group consisting of an electric guitar, an electric violin, and an electric bass guitar.
